(19) United States
(12) Patent Application Publication
(10) Pub. No.: US 2022/0147875 A1
(43) Pub. Date: May 12, 2022

(54) REMOVING LESS INFORMATIVE SAMPLES IN SEQUENTIAL DATA

(71) Applicant: dSPACE digital signal processing and control engineering GmbH, Paderborn (DE)

(72) Inventors: Daniel HASENKLEVER, Paderborn (DE); Sven BURDORF, Paderborn (DE); Christian NOLDE, Paderborn (DE)

(73) Assignee: dSPACE digital signal processing and control engineering GmbH, Paderborn (DE)

(21) Appl. No.: 17/525,376

(22) Filed: Nov. 12, 2021

(30) Foreign Application Priority Data
Nov. 11, 2020 (DE) 10 2020 129 675.4

(51) Int. Cl. G06N 20/00; G06F 16/2455

(52) U.S. Cl. CPC G06N 20/00; G06F 16/24556

(57) ABSTRACT

A method of reducing training data via a system having an encoder, wherein at least a portion of the training data forms a temporal sequence and is combined into a first set of training data, and the encoder maps input data to prototype feature vectors of a set of prototype feature vectors. A first input datum is received from the first set of training data, and propagated by the encoder. The input datum is assigned one or more feature vectors by the encoder, and depending on the assigned feature vectors, a defined set of prototype feature vectors is determined and assigned to the first input datum. An aggregated vector is created for the first input datum. A second aggregated vector is created for the second input datum and the first and second aggregated vectors are compared and a measure of similarity for the aggregated vectors is determined.

This nonprovisional application claims priority under 35 U.S.C. § 119(a) to German Patent Application No. 10 2020 129 675.4, which was filed in Germany on Nov. 11, 2020, and which is herein incorporated by reference.

### BACKGROUND OF THE INVENTION

### Field of the Invention

The present invention relates to a method for reducing training data.

### Description of the Background Art

From Tianyang Wang, Jun Huan, Bo Li; “Data Dropout: Optimizing Training Data for Convolutional Neural Networks”; 2018 in IEEE 30th International Conference on Tools with Artificial Intelligence (ICTAI), it is known that artificial neural network (ANN) training can be improved by selectively reducing the training data. In this case, training is performed in two steps, wherein the first part of training is done with the full training dataset and the second part of training with a reduced dataset.

US 2021/0335018, which is incorporated herein by reference, is directed to a data generating device, training device, and a data generating method.

US 2021/0335469, which is incorporated herein by reference, is directed to a system for assigning concepts to a medical image that includes a visual feature module and a tagging module. The visual feature module is configured to obtain an image feature vector from the medical image. The tagging module is configured to apply a machine-learned algorithm to the image feature vector to assign a set of concepts to the image.

US 2021/0335061, which is incorporated herein by reference, is directed to techniques for monitoring and predicting vehicle health.

From Vishesh Devgan et al. “Using a Novel Image Analysis Metric to Calculate Similarity of Input Image and Images Generated by WAE,” 2019 IEEE, which is incorporated herein by reference, there is presented a quasi Euclidean distance metric as a reliable means for measuring image similarity in certain cases.

### SUMMARY OF THE INVENTION

It is therefore an object of the present invention to provide a more efficient method for reducing the training data, which preferably avoids training with the complete, non-reduced training data set.

According to an exemplary embodiment, a method is provided by reducing training data via a system comprising an encoder, wherein at least a portion of the training data forms a temporal sequence and is combined into a first set of training data, and the encoder maps input data to prototype feature vectors of a set of prototype feature vectors, a) a first input datum is received from the first set of training data, b) the first input datum is propagated by the encoder, wherein the input datum is assigned one or more feature vectors by the encoder, and depending on the assigned feature vectors, a certain set of prototype feature vectors is determined and assigned to the first input datum, c) an aggregated vector is created for the first input datum, d) the steps a) to c) are performed with a second input datum from the first set of training data and a second aggregated vector is created for the second input datum, e) at least the first and second aggregated vectors are compared and a measure of similarity for the aggregated vectors is determined; and f) the first input datum is flagged or removed from the first set of training data if the determined measure of similarity exceeds a threshold value, wherein flagging or removing results in the first input datum from the first set of training data not being used for a first training.

An advantage of the method according to the invention is that training data can be excluded from the training quickly and efficiently, thus improving the training success. The method also improves the possibility of efficiently performing preprocessing steps. These include, for example, the enrichment of the individual training data with additional information about their content (labeling). Since less data needs to be labeled after the method has been carried out, preprocessing is also more effective.

It is also advantageous that the encoder used according to the invention can be trained with non-prepared data, in particular non-labeled data. This is done, for example, when training an autoencoder that includes the encoder. This unsupervised machine learning is considerably less costly, since the very time-consuming step of labeling or annotating the training data can be dispensed with.

The first set of training data can include video, radar, and/or lidar frames.

A typical type of training data can be, for example, sensor data and here specifically imaging or environment sensing sensors, such as cameras, radar or lidar sensors. Thus, typical training data are video, radar or lidar frames.

The video, radar and/or lidar frames of the first set of training data can be temporal sequences of sensor data, in particular of sensor data recorded during a journey of a vehicle or sensor data artificially generated so that they simulate sensor data of a journey of a vehicle.

A frame represents a snapshot related to a section of the image captured by the sensor. These individual frames usually form sequences of temporally successive single frames. This type of training data as temporal sequences of sensor data is often recorded by vehicles. Here, these vehicles move through the usual road traffic in order to record sensor data typical for this situation. Alternatively, sensor data can also be generated artificially. For this purpose, a fictitious scene, e.g., of road traffic, can be generated in a simulation, and sensor data for a simulated vehicle can be calculated from it. This can be done for time reasons since simulations can run much faster than real driving. Likewise, situations that cannot be easily recreated in reality, such as emergency braking or even accidents, can be easily recreated in simulation. With this kind of sequential training data, it is very common that not all frames contain information important for the training or two frames contain practically [sic] only redundant information. An example is waiting at a red light in traffic. During the wait time, a large number of sensor data are recorded, which, however, do not differ or differ only insignificantly in the aspects relevant for the training.

The first and second input datums of the first set of training data can be consecutive datums in the temporal sequence of the training data.

The training data of the first set of training data can be used to train an algorithm for the highly automated or autonomous control of vehicles.

In the context of developing algorithms for controlling highly automated or autonomous vehicles, a large amount of training data may be required. Since a large part of the algorithms is based on artificial intelligence and in particular deep neural networks, these must be trained with appropriate training data. Further training data is required for testing or validating the developed algorithms. The method according to the invention can be used in particular for the selection of relevant training data from a large set of training data, with which algorithms for highly automated or autonomous vehicles are then trained or tested.

In a further example of the method, steps a) to f) are performed directly when the training data is recorded or generated, and in step f) the first training datum is removed when the threshold value of the measure of similarity is exceeded.

The measured or generated training data, especially sensor data, usually requires a lot of storage space and can only be stored in the vehicle and thus only in limited space when driving in road traffic. Wireless transmission of sensor data is not possible in most cases due to its size. In order to save storage space, the method according to the invention is suitable for being carried out directly after the data has been acquired and for removing data identified as redundant again directly and saving storage space.

In a further example of the method, steps a) through f) are performed prior to training or preprocessing with the training data of the first set of training data.

Likewise, the method according to the invention can also be used at a later time to remove redundant training data from the data set to be used before training or before preprocessing. In particular, this saves time and computational resources in preparing the training data and provides better results during training. Preprocessing includes, in particular, labeling or annotating the training data to be used for training.

The aggregated vector can be a histogram vector that assigns to each protype feature vector an integer representing the respective assigned number of each protype feature vector.

In an example of the method, the measure of similarity in step e) is determined using a cosine similarity.

In an example of the method, the measure of similarity in step e) comprises comparing the first, the second, and a third aggregated vector, wherein the third aggregated vector was generated using steps a) through c) with a third input datum from the first set of training data.

The encoder can be trained as part of an autoencoder.

The encoder can comprise a first set of prototype feature vectors learned during training of the autoencoder.

The encoder and/or the autoencoder can be implemented by, for example, a neural network, in particular a convolutional neural network.

The method according to the invention may also be present as a computer program product comprising program code which, when executed, performs the method.

The method according to the invention may be present in a computer system set up to perform the method.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a schematic sequence of the training data reduction method,

FIG. 2 shows a schematic structure of an autoencoder according to an example of the invention,

FIG. 3 shows a schematic setup of the method for determining aggregated information on training data, and

FIG. 4 shows a schematic sequence of the training data reduction method showing the sequential training data and a comparison.

### DETAILED DESCRIPTION

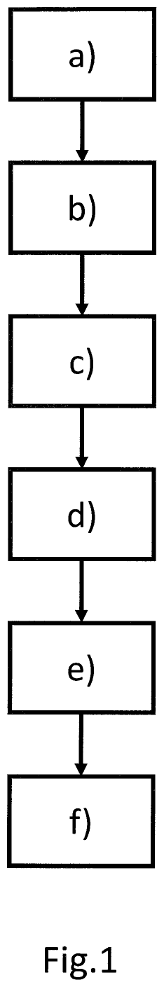

FIG. 1 illustrates the sequence of steps of the method according to the invention. In step a), a first input datum is received from the first set of training data. The training data can be, in particular, frames of a sequence of data. A typical example is a video sequence, which consists of a sequence of images or frames in a certain order. The received input datum is propagated through the encoder (12) of the system in step b), wherein feature vectors are assigned to the input data. In this process, the dimensionality of the input datum is usually reduced so that aspects of the input datum are, in a sense, combined. This combined information about the input datum is called feature vectors. How this mapping to feature vectors is done depends on the parameterization of the encoder (12), which has been learned previously by means of training. This training takes place in advance of the method for the reduction of training data and is carried out with data as similar as possible to the data to be analyzed and reduced later. Similarity here is to be understood from the point of view of the totality of the data sets, which are to be statistically similar, and is not to be evaluated on the similarity of individual data or frames. During the training of the encoder (12), prototype feature vectors were also identified and defined. These correspond to a fixed set of feature vectors that are typical, or characteristic of the data used in training the encoder. This fixed set of prototype feature vectors is also called a “code book”. The feature vectors are mapped to the prototype feature vectors of the code book. This process is also called quantization. The prototype feature vectors found in this way are assigned to the respective input datum propagated by the encoder (12). In step c), an aggregated vector (30) is formed from the respective assigned prototype feature vectors, which summarizes the information contained in the assigned prototype feature vectors. This can be done, for example, in the form of a histogram. In the following step d), steps a) to c) are carried out for a further second input datum analogously to the previously described procedure, resulting in a further second aggregated vector (30) for the second input datum. Now, in order to decide whether the first input datum is so similar to the second that both should not be used in the training, the aggregated vectors (30) of the two input datums are compared in step e). One way of comparison is, for example, via cosine similarity. If the result of the comparison exceeds a defined threshold, a high similarity of the two input data is recognized, and the first input datum is flagged in step f) so as not to be used for training or is removed completely from the first training dataset. In both cases, the first input datum is not used for subsequent training.

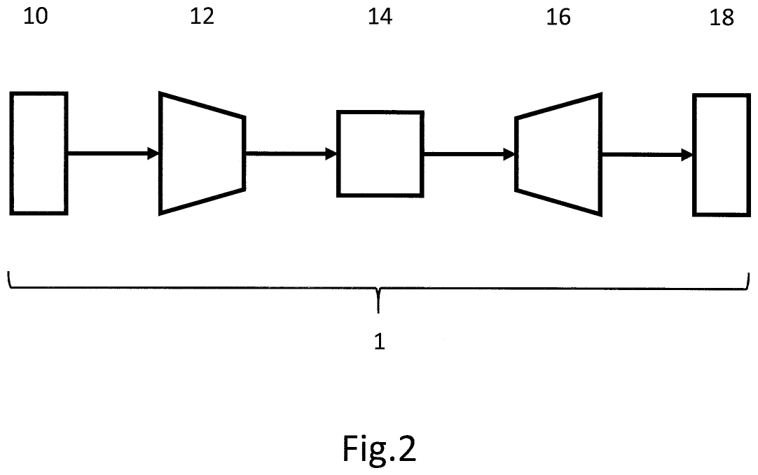

FIG. 2 schematically shows the structure of an autoencoder (1) as it can be used proportionally for the method according to the invention. Data is fed to the encoder (12) by means of the input layer (10). In the vector quantization unit (14), the feature vectors which the encoder (12) outputs as a result of the data fed to it are mapped to a fixed set of prototype feature vectors of the so-called code book. This process is equivalent to quantization in that a fixed number of discrete states or vectors are mapped. An autoencoder (1) further comprises a decoder (16) which reconstructs data for an output layer (18) from a compilation of prototype feature vectors fed to it as a reversal of the encoder (12). The reconstructed data should correspond as closely as possible to the data of the input layer (10). If an autoencoder (1) is trained, the parameters present in the encoder (12) and decoder (14), and the prototype feature vectors of the code book are adapted such that the most accurate possible reconstruction of the input data (10) in the output data layer (18) takes place.

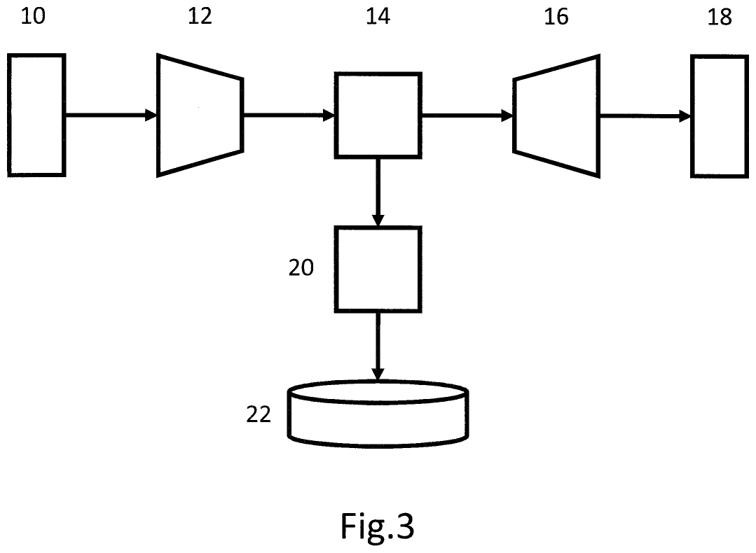

FIG. 3 schematically shows the setup for determining aggregated information or aggregated vectors (30) of the method according to the invention. The input layer (10), as well as the encoder (12) and the vector quantization unit (14) are shown as already shown and described in FIG. 2. Further shown is an aggregation unit (20), which is fed the prototype feature vectors determined for an input datum. This generates an aggregated vector (30) which combines information from all prototype feature vectors associated with an input datum. For example, this can be done in the form of a histogram vector. Here, a vector of length N is formed, wherein N is the number of prototype feature vectors in the code book, and for each prototype feature vector, the number of times the corresponding prototype feature vector was assigned to the respective input datum is stored in the respective row of the histogram vector. However, other forms of information aggregation, such as an averaging or similar, are also possible. This information, in the form of the aggregated vectors (30), is then stored in a data store (22), such as a database, with its association to the corresponding input datum from the set of training data. They can then be further used either immediately or at a later time in the method according to the invention to determine the similarity of two input datums and to decide whether one of the input datums should not be used for training.

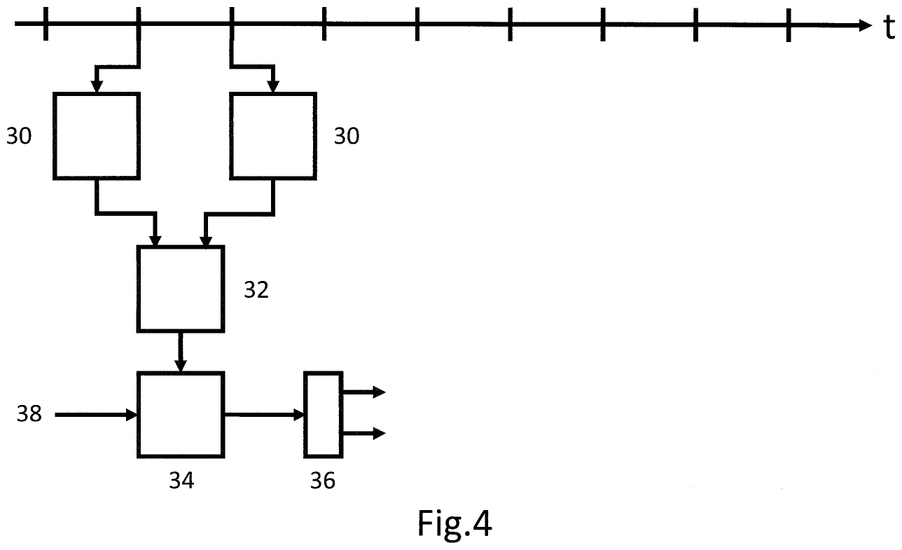

FIG. 4 shows a view of the sequential training data and the sequence of a comparison of two of these training datums. The axis designated with t schematically shows the sequential order of the input data. For each input datum, a corresponding aggregated vector was generated according to steps a) to c) and stored as shown in FIG. 3. The aggregated vectors (30) of two temporally adjacent input datums are now compared in a comparison unit (32) and their similarity is determined in the form of a measure. For example, a cosine similarity can be used here. In a threshold unit (34), which receives a threshold value (38) with respect to the measure of similarity, it is determined whether the similarity of the two aggregated vectors (30) is above the threshold value (38) or not. Based on this determination, a decision unit (36) determines whether to use both input dates for training or to discard the first input datum for training. This can be done by a special flagging or removal of the input datum. It is advantageous to always discard the temporally first input datum, since this ensures that the input datum temporally following the second input datum can be compared again with its direct temporal predecessor, if the method according to the invention is to be applied to further or even all input data of the training data set.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method for the reduction of training data, via a system comprising an encoder, wherein at least part of the training data forms a temporal sequence and is combined in a first set of training data, and the encoder maps input data to prototype feature vectors of a set of prototype feature vectors, the method comprising:
a) receiving a first input datum from the first set of training data;
b) propagating the first input datum by the encoder, wherein one or more feature vectors are assigned to the input datum by the encoder, and depending on the assigned feature vectors, a defined set of protype feature vectors is determined and assigned to the first input datum;
c) creating an aggregate vector for the first input datum;
d) performing steps a) through c) with a second input datum from the first set of training data and creating a second aggregate vector for the second input datum;
e) comparing at least the first and second aggregated vectors and determining a measure of similarity for the aggregated vectors; and
f) flagging or removing the first input datum from the first set of training data when the determined measure of similarity exceeds a threshold,
wherein the flagging or removing results in the first input datum from the first training set not being used for a first training.

2. The method according to claim 1, wherein the first set of training data comprises video, radar and/or lidar frames.

3. The method according to claim 2, wherein the video, radar and/or lidar frames of the first set of training data are temporal sequences of sensor data or sensor data which have been recorded during a journey of a vehicle or sensor data which have been artificially generated so that they simulate sensor data of a journey of a vehicle.

4. The method according to claim 1, wherein the first and second input datums of the first set of training data are temporally consecutive datums in the temporal sequence of the training data.

5. The method according to claim 1, wherein the training data of the first set of training data is used to train an algorithm for highly automated or autonomous control of vehicles.

6. The method according to claim 1, wherein the steps a) to f) are performed directly when recording or generating the training data of the first set of training data, and in step f) the first input datum is removed from the first set of training data when the threshold value of the measure of similarity is exceeded.

7. The method according to claim 1, wherein the steps a) to f) are performed prior to training or preprocessing with the training data of the first set of training data.

8. The method according to claim 1, wherein the aggregated vector is a histogram vector that assigns to each protype feature vector an integer representing the respective assigned number of the respective protype feature vector.

9. The method according to claim 1, wherein the measure of similarity in step e) is determined via a cosine similarity.

10. The method according to claim 1, wherein the measure of similarity in step e) comprises comparing the first, the second, and a third aggregated vector, wherein the third aggregated vector was generated using steps a) through c) with a third input datum from the first set of training data.

11. The method according to claim 1, wherein the encoder has been trained as part of an autoencoder.

12. The method according to claim 11, wherein the encoder comprises a first set of prototype feature vectors learned during the training of the autoencoder.

13. The method according to claim 1, wherein the encoder and/or the autoencoder are implemented via a neural network or a convolutional neural network.

14. A computer program product, comprising program code which, when executed, performs the method of claim 1.

15. A computer system, set up to perform the method of claim 1.
